(19) United States
(12) Patent Application Publication
(10) Pub. No.: US 2021/0354175 A1
(43) Pub. Date: Nov. 18, 2021

(54) METHODS OF CLEANING AUTOMATED RECIRCULATION SYSTEMS AND USING WASTE EFFLUENT GENERATED THEREFROM

(71) Applicant: Diversey, Inc., Fort Mill, SC (US)

(72) Inventors: Flemming Skou, Farum (DK); Ingo Mistele, Mannheim (DE); Bernd Paulus, Dossenheim (DE)

(73) Assignee: Diversey, Inc., Fort Mill, SC (US)

(21) Appl. No.: 17/285,146

(22) PCT Filed: Oct. 31, 2019
(86) PCT No.: PCT/US19/59049

§ 371 Date: Apr. 14, 2021

Related U.S. Application Data
(60) Provisional application No. 62/753,217, filed on Oct. 31, 2018.

(51) Int. Cl. B08B 3/08; C11D 11/00; C11D 3/30

(52) U.S. Cl. CPC B08B 3/08; C11D 3/30; C11D 11/0041

(57) ABSTRACT

Disclosed therein are the methods of cleaning an automated recirculation system or equipment and using the waste effluent produced therefrom for use without the need to reduce the conductivity of such waste effluent prior to use. The method comprises cleaning the automated recirculation system or equipment with a cleaning solution having a conductivity of up to 8 mS/cm at 25° C., and generating a waste effluent. The waste effluent may be used as irrigation water without reducing conductivity of the waste effluent prior to irrigation use. Suitable automated recirculation systems or equipment may be those used in the processing operation of a processed food, dairy, brewing, or beverage. The automated recirculation system may be a clean-in-place (CIP) system.

### CROSS-REFERENCE TO RELATED APPLICATION

This application claims the benefit of and priority to U.S. Provisional Patent Application No. 62/753,217, filed 31 Oct. 2018, the entire contents of which are hereby incorporated by reference.

### TECHNICAL FIELD

The present application relates to the methods of cleaning automated recirculation systems or equipment, and more specifically, to the methods of cleaning automated recirculation systems or equipment that generate a waste effluent suitable for irrigation use.

### BACKGROUND

Electric conductivity (hereinafter “conductivity”) is a measure of material's ability to conduct electricity. The conductivity of water-based liquid is directly related to the concentration of ions in water. These conductive ions come from dissolved salts and inorganic materials such as alkalis, chlorides, sulfides and carbonate compounds. The more ions that are present, the higher the conductivity of water-based liquid. Likewise, the fewer ions that are present, the lower the conductivity of water-based liquid. Conductivity is usually measured in micro- or milliSiemens per centimeter (μS/cm or mS/cm). Specific conductance is a conductivity measurement made at or corrected to 25° C., and it is the standardized method of reporting conductivity.

Distilled water has a conductivity in the range of 5×10⁻⁴ to 3×10⁻³ mS/cm. Tap water has a conductivity in the range of 0.05 to 0.8 mS/cm. Industrial waste effluent could have a conductivity as high as 850 mS/cm. Therefore, there are governmental regulations to limit the conductivity level of waste effluent that is discharged from manufacturing sites. As a result, waste effluent must be treated to reduce the conductivity level before being released from manufacturing sites.

The high level of conductivity (i.e., high level of ions) in waste effluent also limits its use as irrigation water for crops. When irrigating crops with water having higher salinity (i.e., higher conductivity) than the crops can tolerate, yield loss and decreased quality of crops would occur. Crop yields are usually markedly reduced before visual symptoms of salinity damage become apparent. For example, excessive concentrations of sodium and chloride ions in irrigation water can cause toxicities in plants. Typical sodium toxicity symptoms are leaf burn, scorch and dead tissue along the outside edges of leaves. Another effect of sodium is that if sodium is high in relation to calcium and magnesium, waterlogging may result due to the degradation of well-structured soils. Typical chloride toxicity symptoms are burning of leaf tips or margins, bronzing and premature yellowing of the leaves.

Plants vary in their tolerance to saline water. Pitman and Läuchli reported the classification of crops based on their salt tolerances as shown in the table below. Threshold conductivity of irrigation water is the maximum conductivity of irrigation water that the crops can tolerate without resulting in a loss in crop yield. See Pitman, M. G. and Läuchli, A. (2002) Global Impact of Salinity and Agricultural Ecosystems, in: Läuchli, A. and Lüttge, U., Eds., Salinity: Environment-Plants-Molecules, Springer, Berlin, 3-20.

| | | Threshold conductivity |
|---|---|---|
| | | of irrigation water |
| Salt tolerance rating | Crop | (mS/cm) |
| Sensitive | Bean | 1.0 |
| | Strawberry | 1.0 |
| Moderately sensitive | Corn, Potato | 1.7 |
| | Alfalfa | 2.0 |
| | Rice | 3.0 |
| Moderately Tolerant | Soybean | 5.0 |
| | Wheat | 6.0 |
| | Sorghum | 6.8 |
| Tolerant | Sugar beet | 7.0 |
| | Cotton | 7.7 |
| | Barley | 8.0 |

The waste effluent from manufacturing sites having conductivity levels within the governmental regulations may still have too high conductivity to be used as irrigation water. Such waste effluent must be further treated to reduce its conductivity level, prior to its use as irrigation water for crops. Several methods have been reported for reducing the conductivity level of waste effluent, so that the treated waste effluent has sufficiently low conductivity suitable for use as irrigation water. See, e.g., U.S. Pat. Nos. 6,328,875; 6,315,886; 5,009,791.

Automated recirculation systems in possessing plants typically generate a waste effluent that is a water-based liquid. For example, clean-in-place (CIP) methods are commonly used to clean equipment in the processed food, dairy, brewing, or beverage processing plants. CIP methods involve filling the equipment with cleaning solutions, and then flushing such solutions from the equipment to remove any contaminant from the equipment surfaces. Conventional CIP methods involve rinsing the equipment with ambient to lukewarm water (temperature range of 5° C. to 50° C.); followed by cleaning the equipment with a cleaning solution at a temperature range of 0° C. to 85° C. The cleaning solution contains an acidic agent, an alkalinity agent, an oxidizing agent, a disinfecting agent, or any combination thereof, depending on whether a processed food, dairy, brewing, or beverage processing plant is being cleaned. In certain exemplary conventional automated recirculation systems, the alkaline cleaning solutions contain about 1 wt % of caustic soda and have a conductivity of about 45 mS/cm at 25° C., while the acid cleaning solutions contain about 1 wt % of nitric acid and have a conductivity of about 60 mS/cm at 25° C. The final step in CIP methods typically involves rinsing the equipment with water at ambient temperature. When desired, such final rinse step may include an acidic rinse (a phosphoric acid-based wash has conventionally been used), a disinfectant, and/or a sanitizer. The waste effluent generated from the cleaning process is typically composed of the rinse solutions in combination with at least a portion of the cleaning solution. Such waste effluent has a high conductivity level, and must be treated to reduce its conductivity level before being released from the manufacturing plants or being used for other applications.

There remains a need in the art for a method of cleaning an automated recirculation system (e.g., a CIP operation) or equipment that generates a waste effluent having sufficiently low conductivity for its use as irrigation water, without the need to reduce the conductivity of waste effluent before the irrigation use. Such method not only reduces the costs associated with disposal of the waste effluent from the cleaning operation, but also adds value benefits associated with utilizing the waste effluent as irrigation water. Furthermore, such method must have at least comparable ability to clean the equipment as compared to the method of cleaning known in the art.

### SUMMARY

The present disclosure relates to the methods of cleaning an equipment and using the waste effluent produced therefrom for use without the need to reduce the conductivity of such waste effluent prior to use.

In one aspect of the present disclosure, the method comprises cleaning an automated recirculation system with a cleaning solution having a conductivity of up to 8 mS/cm at 25° C.; generating a waste effluent; and using the waste effluent as irrigation water without reducing conductivity of the waste effluent prior to irrigation use.

In another aspect of the present disclosure, the method comprises providing a cleaning solution having a conductivity of up to 8 mS/cm at 25° C.; contacting an equipment to be cleaned with the cleaning solution for a time needed to achieve a desired extent of soil removal and generating a waste effluent; discharging the generated waste effluent from the equipment; and using the waste effluent without reducing conductivity of the waste effluent prior to use, wherein the waste effluent has a conductivity of no more than 8 mS/cm at 25° C.

In a further aspect of the present disclosure, the method comprises providing a cleaning solution having a conductivity of up to 8 mS/cm at 25° C.; contacting an equipment to be cleaned with the cleaning solution for a time needed to achieve a desired extent of soil removal and generating a waste effluent; discharging the generated waste effluent from the equipment; and using the waste effluent as irrigation water without reducing conductivity of the waste effluent prior to irrigation use.

### BRIEF DESCRIPTION OF THE DRAWINGS

FIG. 1 is a flowchart showing the steps in a method of cleaning an automated recirculation system and using waste effluent produced therefrom according to an embodiment of the disclosure;

FIG. 2 is a flowchart showing the steps in another method of cleaning an automated recirculation system and using waste effluent produced therefrom according to an embodiment of the disclosure;

FIG. 3 is a flowchart showing the steps in yet another method of cleaning an automated recirculation system and using waste effluent produced therefrom according to an embodiment of the disclosure;

FIG. 4 is a flowchart showing the steps in still yet another method of cleaning an automated recirculation system and using waste effluent produced therefrom according to an embodiment of the disclosure; and

FIG. 5 is a flowchart showing the steps in even still yet another method of cleaning an automated recirculation system and using waste effluent produced therefrom according to an embodiment of the disclosure.

### DETAILED DESCRIPTION

The present disclosure relates to methods of cleaning an equipment and using the waste effluent produced therefrom for irrigation use without the need to reduce the conductivity of such waste effluent prior to the irrigation use.

The terms “comprise(s),” “comprising,” “include(s),” “including,” “having,” “has,” “contain(s),” “containing,” and variants thereof, as used herein, are open-ended transitional phrases, terms, or words that are meant to encompass the items listed thereafter and equivalents thereof as well as additional items. The singular forms “a”, “and”, and “the” include plural references unless the context clearly dictates otherwise. Where the term “comprising” is used, the present disclosure also contemplates other embodiments “comprising”, “consisting of”, or “consisting essentially of” elements presented herein, whether explicitly set forth or not.

Any numerical range recited herein includes all values from the lower value to the upper value. For example, if an amount range is stated as “from 1% to 50%”, it is intended that values such as from 2% to 40%, from 10% to 30%, or from 1% to 3%, etc., are expressly enumerated in this specification. These are only examples of what is specifically intended, and all possible combinations of numerical values between and including the lowest value and the highest value enumerated are to be considered to be expressly stated in this application.

The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

In general, the amount of a component in a composition as disclosed herein is expressed “% by weight” or “% wt” which refers to the percentage of the component's weight in the total weight of the composition. Unless indicated otherwise, all concentrations are expressed as weight percentage concentrations.

Pursuant to one aspect of the present disclosure, the disclosed method comprises cleaning an automated recirculation system with a cleaning solution having a conductivity of up to 8 mS/cm at 25° C.; generating a waste effluent; and using the waste effluent as irrigation water without reducing conductivity of the waste effluent prior to irrigation use.

The automated recirculation systems suitable for the disclosed method may include, but not limited to, those systems used in processed food, dairy, brewing, or beverage processing operation. As a non-limiting example, the automated recirculation systems may be clean in place (CIP) systems. In some embodiments, the method is applied to the automated recirculation system that had been operated at a high temperature such that the surfaces of the automated recirculation system contain burnt-in soil. In some embodiments, the method is applied to the automated recirculation system that had not been operated at a high temperature such that the surfaces of the automated recirculation system are substantially free of burnt-in soil.

In some embodiments, the method further comprises preparing the cleaning solution having a conductivity of up to 8 mS/cm at 25° C. from a cleaner composition by diluting the cleaner composition with a diluent, preferably water.

In some embodiments, the automated recirculation system is cleaned with the disclosed cleaning solution at a temperature of from about CPC to about 95° C. The automated recirculation system may be cleaned with the disclosed cleaning solution at any appropriate temperature depending on the selected application. As non-limiting examples, the cleaning temperature may be in a range of from about CPC to about 10° C. for the cleaning of a fermentation tank in brewing operation; from about 80° C. to about 90° C. for the cleaning of brew house in brewing operation; from about 50° C. to about 75° C. for the cleaning of a membrane in dairy operation; or from about 50° C. to about 95° C. for the CIP cleaning in dairy operation. Pursuant to another aspect of the present disclosure, the disclosed method comprises providing a cleaning solution having a conductivity of up to 8 mS/cm at 25° C.; contacting an equipment to be cleaned with the cleaning solution for a time needed to achieve a desired extent of soil removal and generating a waste effluent; discharging the generated waste effluent from the equipment; and using the waste effluent without reducing conductivity of the waste effluent prior to use, wherein the waste effluent has a conductivity of no more than 8 mS/cm at 25° C.

Pursuant to further aspect of the present disclosure, the disclosed method comprises providing a cleaning solution having a conductivity of up to 8 mS/cm at 25° C.; contacting an equipment to be cleaned with the cleaning solution for a time needed to achieve a desired extent of soil removal and generating a waste effluent; discharging the generated waste effluent from the equipment; and using the waste effluent as irrigation water without reducing conductivity of the waste effluent prior to irrigation use.

In some embodiments, the equipment is contacted with the cleaning solution at a temperature of from about 0° C. to about 95° C. The equipment may be contacted with the cleaning solution at any appropriate temperature depending on the selected application. As non-limiting examples, the equipment may be contacted with the cleaning solution at a temperature range of from about 0° C. to about 10° C. for the cleaning of a fermentation tank in brewing operation; from about 80° C. to about 90° C. for the cleaning of brew house in brewing operation; from about 50° C. to about 75° C. for the cleaning of a membrane in dairy operation; or from about 50° C. to about 95° C. for the CIP cleaning in dairy operation.

In certain embodiments, the equipment includes a processing equipment in a processed food, dairy, brewing, or beverage processing operation. In some embodiments, the equipment may not have been operated at a higher temperature such that the surfaces of the equipment are substantially free of burnt-in soil. In some embodiments, the equipment may have been operated at a higher temperature such that the surfaces of the equipment contain burnt-in soil.

The cleaning solution suitable for the disclosed method may have a conductivity of up to 8 mS/cm at 25° C., up to 7 mS/cm at 25° C., up to 6 mS/cm at 25° C., up to 5 mS/cm at 25° C., up to 4 mS/cm at 25° C., up to 3 mS/cm at 25° C., up to 2.5 mS/cm at 25° C., up to 2 mS/cm at 25° C., up to 1.5 mS/cm at 25° C., up to 1.25 mS/cm at 25° C., up to 1 mS/cm at 25° C., up to 0.9 mS/cm at 25° C., up to 0.75 mS/cm at 25° C., or up to 0.5 mS/cm at 25° C.

In some embodiments, the cleaning solutions have a conductivity of up to 5 mS/cm at 25° C., up to 3 mS/cm at 25° C., or up to 1 mS/cm at 25° C.

The suitable cleaning solutions may comprise an acidic agent, an alkalinity agent, an oxidizing agent, a disinfecting agent, or any combination thereof.

In some embodiments, the cleaning solution is an acidic cleaning solution. In further embodiments, the cleaning solution is an acidic cleaning solution and has a conductivity of up to 8 mS/cm at 25° C., up to 5 mS/cm at 25° C., or up to 2 mS/cm at 25° C.

In some embodiments, the cleaning solution is an alkaline cleaning solution. In further embodiments, the cleaning solution is an alkaline cleaning solution and has a conductivity of up to 8 mS/cm at 25° C., up to 5 mS/cm at 25° C., or up to 2 mS/cm at 25° C.

In some embodiments, the cleaning solution is an acidic cleaning solution or an alkaline cleaning solution, and has a conductivity of up to 5 mS/cm at 25° C., up to 2 mS/cm at 25° C., or up to 1 mS/cm at 25° C.

When desired, the cleaning solutions may further comprise a buffer, a hydrotrope, a sequestrant, a solvent, a stabilizer, a biocide, a surfactant, a degreaser, an optically active dye, or any combination thereof.

As used herein, the term “conductivity” means an electric conductivity, which is a measure of material's ability to conduct electricity. The conductivity of aqueous solution is directly related to the concentration of ions in water. Conductivity, as reported herein, is measured in milliSiemens per centimeter (mS/cm) at or corrected to 25° C.

As used herein, the term “acidic agent” means a compound or solution intended to reduce pH of the cleaning solution and/or to remove soil materials from the surface of equipment that would otherwise result in fouling of the equipment. As non-limiting examples, the acidic agent may include methane sulfonic acid, methane sulfonic acid derivative, sulfamic acid, sulfamic acid derivative, alpha-hydroxy acid, alpha-hydroxy acid derivative, formic acid, formic acid derivative, acetic acid, acetic acid derivative, citric acid, citric acid derivative, propionic acid, propionic acid derivative, glutamic acid, glutamic acid derivative, gluconate, gluconate derivative, glycolic acid, glycolic acid derivative, or any combination thereof. As used herein, the term “derivative” includes, but is not limited to, salt, ester, amide, or mixtures thereof.

In some embodiments, the acid cleaner composition comprises up to 100 wt % of an acidic agent, up to 70 wt %, or up to 50 wt % based on total weight of the cleaner composition. In some embodiments, the acid cleaner composition comprises from about 1 wt % to about 100 wt %, from about 5 wt % to about 70 wt %, from about 5 wt % to about 55 wt %, from about 10 wt % to about 70 wt %, from about 10 wt % to about 60 wt %, from about 10 wt % to about 55 wt %, or from about 20 wt % to about 60 wt % of acidic agent based on total weight of the cleaner composition.

In some embodiments, the acid cleaning solution comprises up to 5 wt % of an acidic agent, up to3 wt %, or up to 2 wt % based on total weight of the cleaning solution. In some embodiments, the acid cleaning solution comprises from about 0.01 wt % to about 5 wt %, from about 0.02 wt % to about 5 wt %, from about 0.05 wt % to about 4 wt %, from about 0.05 wt % to about 3 wt %, from about 0.10 wt % to about 2 wt %, from about 1 wt % to about 5 wt %, from about 1 wt % to about 4 wt %, or from about 1 wt % to about 3 wt % of acidic agent based on total weight of the cleaning solution.

As used herein, the term “alkalinity agent” means a compound or solution intended to raise pH of the cleaning solution. As non-limiting examples, hydroxyl ions, carbonate ions, or organic amines may increase the alkalinity (i.e., increase the pH) of the cleaning solution. Examples of alkalinity agents suitable for the present disclosure include, but are not limited to, ammonia, monoethanolamine, triethanolamine, diglycolamine, or any combination thereof.

In some embodiments, an alkaline cleaner composition may comprise up to 100 wt % of an alkalinity agent, up to 80 wt %, up to 60 wt %, or up to 50 wt % based on total weight of the cleaner composition. In some embodiments, the alkaline cleaner composition comprises from about 1 wt % to about 100 wt %, from about 5 wt % to about 70 wt %, from about 5 wt % to about 55 wt %, from about 10 wt % to about 70 wt %, from about 10 wt % to about 60 wt %, from about 10 wt % to about 55 wt %, or from about 20 wt % to about 60 wt % of acidic agent based on total weight of the cleaner composition.

In some embodiments, an alkaline cleaning solution may comprise up to 5 wt % of an alkalinity agent, up to 4 wt %, up to 3 wt %, or up to 2 wt % based on total weight of the cleaning solution. In some embodiments, the alkaline cleaning solution comprises from 0.01 wt % to about 5 wt %, from 0.2 wt % to about 5 wt %, from about 0.05 wt % to about 4 wt %, from about 0.05 wt % to about 3 wt %, from about 0.10 wt % to about 2 wt %, from about 1 wt % to about 5 wt %, from about 1 wt % to about 4 wt %, or from about 1 wt % to about 3 wt % of acidic agent based on total weight of the cleaning solution.

In some embodiments, an alkaline cleaner composition comprises from about 1 wt % to about 100 wt %, from about 10 wt % to about 100 wt %, from about 10 wt % to about 90 wt %, from about 20 wt % to about 80wt %, from about 5 wt % to about 70 wt %, from about 8 wt % to about 60wt %, from about 9 wt % to about 50 wt %, or from about 10 wt % to about 30 wt % of monoethanolamine based on total weight of the cleaner composition.

In some embodiments, an alkaline cleaning solution comprises from about 0.01 wt % to about 5 wt %, from about 0.02 wt % to about 4 wt %, from about 0.03 wt % to about 3 wt %, from about 0.05 wt % to about 3 wt %, from about 0.05 wt % to about 2 wt %, from about 0.08 wt % to about 2 wt %, from about 0.10 wt % to about 2 wt %, or from about 0.10 wt % to about 1 wt % of monoethanolamine based on total weight of the cleaning solution.

In some embodiments, an alkaline cleaner composition comprises from about 1 wt % to about 100 wt %, from about 10 wt % to about 100 wt %, from about 20 wt % to about 100 wt %, from about 30 wt % to about 100 wt %, from about 10 wt % to about 90 wt %, from about 20 wt % to about 90 wt %, from about 10 wt % to about 80 wt %, from about 15 wt % to about 75 wt %, or from about 15 wt % to about 50 wt % of triethanolamine based on total weight of the cleaner composition.

In some embodiments, an alkaline cleaning solution comprises from about 0.01 wt % to about 5 wt %, from about 0.02 wt % to about 4 wt %, from about 0.03 wt % to about 3 wt %, from about 0.05 wt % to about 3 wt %, from about 0.08 wt % to about 2 wt %, from about 0.09 wt % to about 4 wt %, from about 0.10 wt % to about 3 wt %, from about 0.15 wt % to about 4 wt %, or from about 0.15 wt % to about 2 wt % of triethanolamine based on total weight of the cleaning solution.

As used herein, the term “disinfectant” or “disinfecting agent” means a substance that destroys or irreversibly inactivates infectious or other undesirable bacteria, pathogenic fungi, viruses, and phages on surfaces or inanimate objects. A disinfectant kills the growing forms but not necessarily the resistant spore forms of microorganisms. A disinfectant may comprise a sterilizer, which destroys the growing and spore forms of viruses, bacteria, or fungi on inanimate surfaces. A disinfectant may comprise a sanitizer (which is used to reduce the number of living bacteria or viable virus particles on inanimate surfaces), a fungicide or fungistat (which is used to inhibit the growth of or destroy fungi on surfaces or in solution).

As used herein, the term “oxidizer” or “oxidizing agent” means an agent that gains electrons and is reduced in a chemical reaction. Such agents are also known as the electron acceptor, the compound involved in “oxidation,” the “oxidizer” or the “oxidizing agent” is normally in one of its higher possible oxidation states because it will gain electrons and be reduced. Non-limiting examples of an oxidizer or an oxidizing agent includes hydrogen peroxide or organic peracids.

As used herein, the term “buffer” means a compound that maintains pH of the cleaning solution within a narrow range of limits.

As used herein, the term “hydrotrope” means a compound that helps other compounds become dissolved in a solvent. Due to this action, a hydrotrope may also be known as a solubilizer. Certain hydrotropes may also have a surfactant type quality.

As used herein, the term “optically active dye” means indicator labels included within a cleaning solution for further analysis. In certain, more preferred embodiments of the invention, optically active dyes include, but are not limited to, UV dyes, IR dyes, visible dyes, nanoparticle receptors that include dots, rods or nanobars, surface plasmon resonant particles (PRPs), and resonance light scattering particles (RLSs)—particles of silver or gold that scatter light (the size and shape of PRP/RLS particles determines the wavelength of scattered light). Optically active dyes may also include, fluorescent dyes and fluorospheres.

As used herein, the term “sequestrant” means a compound capable of forming a complex with metal ions that may be present in the cleaning solution. A sequestrant may also function as a threshold agent by delaying or even preventing crystal growth or crystallization. A sequestrant may provide an improved control of water hardness. Further, a sequestrant may assist with the control of dissolved fats.

As used herein, the term “solvent” is a solution included to, e.g., provide product stabilization, act as degreaser/emulsifier, or both. Non-limiting examples of degreaser/emulsifier solvents include, but are not limited to, alcohol, glycol, glycerin, ether, or any mixture thereof. More specific exemplary degreaser/emulsifier solvents include, but are not limited to a glycol ether, an oil, a fatty acid, an alkane, a terpene, a ketone, toluene or derivative thereof, a dipropylene glycol methyl ether, or any combination thereof.

As used herein, the term “stabilizer” means a compound that is capable of imparting a chemical stability to the cleaning solution, and/or protecting other compounds in the cleaning solution so that those compounds can be allowed to perform their desired function.

As used herein, the term “surfactant” means a compound that may perform any combination of wetting and even penetrating the surface of the soil to be cleaned, loosening deposited soils at the surface of the equipment, and emulsifying the soils to keep them suspended in solution for removal from the equipment. Surfactants tend to also reduce the surface tension in the cleaning solution. Conventionally, surfactants have been chosen in the cleaning solution for a particular temperature of use. The surfactant used in the present disclosure has a cloud point temperature below the temperature of cleaning operation. In certain embodiments of the present disclosure, a plurality of surfactants are chosen such that the surfactants have staggered cloud point temperatures allowing the cleaning solution to be effectively used over a broader temperature range.

As used herein, the term “waste effluent” means the liquid waste resulted from cleaning of equipment, such as the equipment used in the processed food, dairy, brewing, or beverage processing plants. Waste effluent may be recovered and processed into other products, such as for feedstock. However, the main component in the waste effluent is water. Therefore, the cost to recover and process the waste effluent into other product is rather high. Generally, waste effluent is released from the processing plants, after being treated to comply with the governmental regulations for waste water.

FIG. 1 is a flowchart showing a method of cleaning an automated recirculation system and using waste effluent produced therefrom according to one embodiment of the present disclosure. The method (1) includes the step of preparing a cleaning solution from a cleaner composition (10), wherein the cleaning solution may comprise an acidic agent, an alkalinity agent, an oxidizing agent, a disinfecting agent, or any combination thereof. As a non-limiting example, the cleaning solution may be prepared by diluting the cleaner composition with a diluent, preferably water. The method further includes the step of cleaning the automated recirculation system with a cleaning solution (20), and optionally the step of rinsing the automated recirculation system with water (30), to generate a waste effluent. The final step involves using the waste effluent for irrigation of crops without reducing the conductivity of waste effluent prior to the irrigation use (40).

In some embodiments, the step of cleaning the automated recirculation system with a cleaning solution (20) may include the use of rinsing, forward flushing, scrubbing, and/or back flushing in conjunction with soaking the automated recirculation system in the cleaning solution in order to ensure, e.g., the removal of particulates and oxidized organic matter from the system.

In some embodiments, the disclosed method may further comprise the step of collecting the waste effluent, or the step of diluting the waste effluent with a diluent, or both steps.

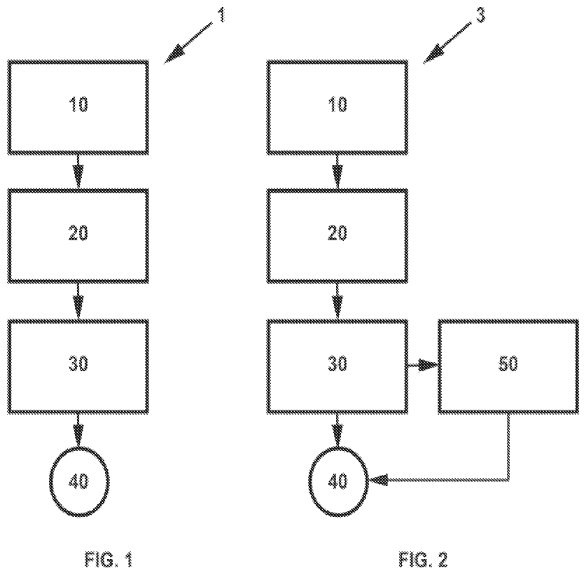

FIG. 2 is a flowchart showing a method of cleaning an automated recirculation system and using waste effluent produced therefrom according to another embodiment of the present disclosure. The method (3) further includes the step of directing the waste effluent to a collection point (50). In some embodiments, all of the waste effluent is directed to the collection point. In some embodiments, only a portion of the waste effluent is directed to the collection point. In certain embodiments of the present disclosure, at most about 10 wt %, at most about 20 wt %, at most about 30 wt %, at most about 40 wt %, at most about 50 wt %, at most about 60 wt %, at most about 70 wt %, at most about 80 wt %, or at most about 90 wt % of the waste effluent is directed to the collection point.

In some embodiments of the disclosed method, a cleaning solution comprises a sequestrant that is capable of complexing with the metal ions. The waste effluent may be subjected to any method known in the art for a fluid treatment, in order to remove the metal complex contained in the waste effluent, and also perhaps to inhibit the formation of scale or solids when the waste effluent is used as irrigation water.

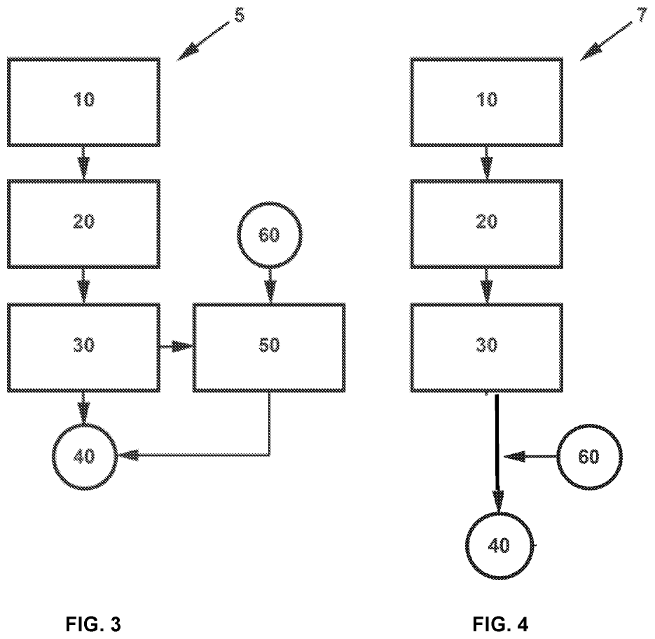

FIG. 3 is a flowchart showing a method of cleaning an automated recirculation system and using waste effluent produced therefrom according to yet another embodiment of the present disclosure. The method (5) further includes the step of directing the waste effluent to a collection point (50), and the step of diluting the waste effluent with a diluent (60).

FIG. 4 is a flowchart showing a method of cleaning an automated recirculation system and using waste effluent produced therefrom according to still another embodiment of the present disclosure. The method (7) further includes the step of diluting the waste effluent with a diluent (60) without collecting the waste effluent as shown in FIG. 3. Such dilution may be performed before using the waste effluent as irrigation water (40).

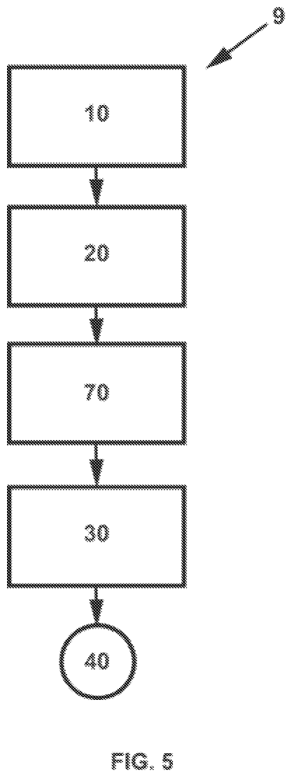

FIG. 5 is a flowchart showing a method of cleaning an automated recirculation system and using waste effluent produced therefrom according to still yet another embodiment of the present disclosure. The method (9) further includes a second cleaning step (70) after the first cleaning step (20) and before the optional rinsing step (30). As a non-limiting example, the first cleaning solution may have a higher conductivity than the second cleaning solution. The second cleaning solution may be utilized not only for cleaning of the automated recirculation system or equipment, but also for adjusting the conductivity so that the waste effluent (40) have the desired conductivity suitable for use as irrigation water. In certain embodiments, another rinsing step may be included between the first cleaning (20) and the second cleaning (70) of the automated recirculation system. When desired, more than two cleaning solutions and/or more than two cleaning steps may be performed.

The disclosed method may comprise more than one collection steps of waste effluent. The method may comprise more than one dilution steps of waste effluent. The method may comprise more than one collection steps and more than one dilution steps of waste effluent. When the method includes more than one step of collecting and/or diluting of waste effluent, such steps may be conducted in parallel series. Also when the method includes more than one step of collecting and/or diluting steps of waste effluent, such steps may be conducted in sequential series. Still further, when the method includes more than one step of collecting and/or diluting of waste effluent, such steps may be conducted in parallel series, as well as sequential series.

In some embodiments of the present disclosure, the cleaning solution may comprise an optically active dye, such as a food dye. In such certain embodiments, a fluid stream may be drawn from the automated recirculation system or equipment, and then analyzed to determine the extent of the optically active dye within the fluid stream. This analysis may be used, for example and without limitation, to control the cleaning step, to minimize water usage, to monitor the process or stream metric, or any combination thereof. The fluid stream sample may be quantitatively analyzed for the level of metal ions by any appropriate techniques known in the art. Examples of such analyses include, but are not limited to, photometrical analysis, UV analysis, visible analysis, IR light analysis, or any combination thereof.

In some embodiments of the disclosed method, the step of preparing a cleaning solution from a cleaner composition (e.g., shown as the step “10” in FIGS. 1-5) may include controlling the concentration and/or the dosing volume of cleaner composition used in the preparation of the cleaning solution. Upon controlling/adjusting the concentration and/or the dosing volume of cleaner composition used in the preparation of the cleaning solution, the desired level of cleaning performance may be obtained. The control may be based on any sensor measurement known in the art. Suitable sensor measurements may include, but are not limited to, an absorption spectroscopy sensor measurement such as an UV absorption spectroscopy measurement; a conductivity measurement; a pH measurement; a turbidity measurement; a refractive index measurement; a polarimetry measurement; a redox potential measurement; or any combination thereof.

The fluid stream may be analyzed to monitor and/or control the concentration of cleaning solution in the automated recirculation system or equipment. In some embodiments, the fluid stream may be analyzed using in-line measurement. In some embodiments, a sample of the fluid stream may be taken from the automated recirculation system or equipment, and then analyzed.

In certain embodiments of the present disclosure, the method further comprises determining the change in processing parameter(s) that is required in order to achieve the desired cleaning performance. Non-limiting examples for the changes in processing parameter(s) may include adjusting a concentration of the cleaner composition, adjusting a dosage volume of the cleaner composition, changing the cleaner composition, adding a rinse step, determining an end point of the rinse, changing the flow rate of fluid stream in the automated recirculation system, adjusting a temperature of the automated recirculation system, or any combination thereof.

As a non-limiting example, the disclosed method may comprise using a sensor measurement to determine the concentration of the cleaning solution in the fluid stream; and then determining and implementing the process change required to achieve the desired concentration of the cleaning solution in the fluid stream. One or more sensor measurements may be used. Suitable sensor measurements may include, but are not limited to, an absorption spectroscopy measurement, a conductivity analyzer, a pH analyzer, a turbidity analyzer, and any combination thereof.

Many modifications and other embodiments of the invention set forth herein will come to mind to one skilled in the art to which this invention pertains having the benefit of the teachings presented in the descriptions herein. It will be appreciated by those skilled in the art that changes could be made to the embodiments described herein without departing from the broad inventive concept thereof. Therefore, it is understood that this invention is not limited to the particular embodiments disclosed, but it is intended to cover modifications within the spirit and scope of the present invention as defined by the included claims.

### EXAMPLES

For acidic cleaner compositions, two examples of the disclosed acidic cleaner compositions (“AC-1” and “AC-2”) were prepared and tested, in comparison to a commercial acidic cleaner composition available from Diversey, Inc., and a commercial nitric add at 53% active.

| | Acidic Cleaner | |
|---|---|---|
| Ingredient | Composition | |
| (reported in gram unit) | AC-1 | AC-2 |
| Water (softened) | 25.9 | 44.0 |
| Methane sulfonic acid, 70% | 5.1 | — |
| Formic acid, 85% | 60.0 | 55.0 |
| Alkyl (C8) ether (8EO) carboxylic acid, 88% | 6.0 | — |
| Alcohol (C8-10) alkoxylate (EO/PO) benzyl capped | 3.0 | 1.0 |
| Total | 100.0 | 100.0 |

For alkaline cleaner compositions, two examples of the disclosed alkaline cleaner compositions (“AL-1” and “AL-2”) were prepared and tested, in comparison to a commercial basic cleaner composition available from Diversey, Inc., and a commercial caustic soda at 50% active.

| | Alkaline Cleaner | |
|---|---|---|
| Ingredient | Composition | |
| (reported in gram unit) | AL-1 | AL-2 |
| Water (softened) | 61.5 | 58.5 |
| Alcohol (C13-15) Alkoxylate (EO/PO) | 0.2 | 0.2 |
| Alkyl (C8) amino dipropionate mono sodium salt, 40% | 0.5 | 0.5 |
| Alkyl (C8-10) polyglycoside, 70% | 0.8 | 0.8 |
| Polyacrylic acid, Mw of 4500, partly neutralized, 45% | 2.0 | 2.0 |
| Ethylene diamine tetra acidic acid sodium salt, 40% | 20.0 | 20.0 |
| Monoethanolamine, 99% | 15.0 | — |
| Triethanolamine, 99% | — | 18.0 |
| Total | 100.0 | 100.0 |

### Conductivity Measurement

Each of the tested cleaner compositions was diluted with deionized water to provide a cleaning solution that contained 1% by weight of the cleaner composition based on total weight of the cleaning solution. The exception was tap water, which was used as a control and measured for its conductivity without dilution. The conductivity was measured at 25° C. and reported in milliSiemens per centimeter unit (mS/cm). Table 1 shows the conductivity of the cleaning solution that contained about 1% by weight of the tested cleaner composition based on total weight of the cleaning solution.

TABLE 1

| | | Conductivity at 1% wt of |
|---|---|---|
| | | the cleaner composition |
| | Cleaner Composition | (mS/cm at 25° C.) |
| Control | Tap Water | 0.8 |
| Acidic Cleaner | AC-1 | 2.8 |
| Composition | AC-2 | 1.9 |
| | Commercial Acid Cleaner | 12.3 |
| | Nitric Acid, 53% active | 33.5 |
| Alkaline Cleaner | AL-1 | 1.0 |
| Composition | AL-2 | 0.8 |
| | Commercial Alkaline | 13.2 |
| | Cleaner | |
| | Caustic Soda, 50% active | 27.8 |

As shown above, each of the cleaning solution containing the disclosed acidic cleaner composition (AC-1 or AC-2) or the disclosed alkaline cleaner composition (AL-1 or AL-2) at 1% by weight based on total weight of the cleaning solution, had a conductivity of up to 8 mS/cm at 25° C. In fact, the disclosed cleaning solution obtained from AC-1, AC-2, AL-1, or AL-2 had a conductivity of less than 3.0 mS/cm at 25° C. On the other hand, the commercially available acidic cleaner composition and basic cleaner composition have a conductivity above 10 mS/cm at 25° C.

### Cleaning Performance

Each of the tested cleaning solutions contained 1% by weight of he cleaner composition based on total weight of the cleaning solution.

The cleaning test was performed as follows: A stainless steel plate was weighted to obtain the “initial weight.” The plate was spread over with two layers of milk, allowed to dry at room temperature overnight, and then weighted to obtain the “soiled weight.” Then, the milk-soiled plate was immersed in the tested cleaning solution for 10 minutes at 70c′a After that, the plate was removed from the cleaning solution, rinsed with water, dried, and then weighted again to obtain the “cleaned weight.”

The % of cleaning performance was calculated using the following equations:

$$Soil weight BEFORE cleaning = Soiled Weight - Initial Weight$$

$$Soil weight AFTER cleaning = Cleaned Weight - Initial Weight$$

$$\% Cleaning Performance = 100 - ( \frac{Soiled weight AFTER cleaning \times 100}{Soil weight BEFORE cleaning} )$$

Table 2 shows the cleaning test results for each of the cleaning solutions. Each of the cleaning solutions was tested twice, and the % average cleaning performance was reported.

TABLE 2

| Cleaning Solution | | | | | | | | |
|---|---|---|---|---|---|---|---|---|
| containing 1% wt of | | | | Soil weight | | Soil weight | Cleaning | Averaged |
| the following | Plate | Initial | Soiled | before | Cleaned | after | performance | cleaning |
| Cleaner Composition | No. | weight (g) | weight (g) | cleaning (g) | weight (g) | cleaning (g) | [%] | performance |
| AC-1 | 1 | 37.9788 | 38.5389 | 0.5601 | 37.9828 | 0.0040 | 99.3 | 98% |
| | 2 | 38.1169 | 38.6756 | 0.5587 | 38.1400 | 0.0231 | 95.9 | |
| AC-2 | 3 | 38.1194 | 38.6780 | 0.5586 | 38.1420 | 0.0226 | 96.0 | 96% |
| | 4 | 38.1607 | 38.7216 | 0.5609 | 38.1869 | 0.0262 | 95.3 | |
| AL-1 | 5 | 38.0280 | 38.5841 | 0.5561 | 38.1618 | 0.1338 | 75.9 | 78% |
| | 6 | 38.0608 | 38.5854 | 0.5246 | 38.1648 | 0.1040 | 80.2 | |
| AC-2 | 7 | 38.1164 | 38.7815 | 0.6651 | 38.2713 | 0.1549 | 76.7 | 87% |
| | 8 | 37.9789 | 38.5383 | 0.5594 | 37.9918 | 0.0129 | 97.7 | |
| Local Tap Water | 11 | 37.9172 | 38.4727 | 0.5555 | 38.2024 | 0.2852 | 48.7 | 49% |
| | 12 | 38.1011 | 38.6560 | 0.5549 | 38.3784 | 0.2773 | 50.0 | |
| Commercial Caustic | 13 | 38.2111 | 38.7647 | 0.5536 | 38.4134 | 0.2023 | 63.5 | 60% |
| soda, 50% active | 14 | 38.1287 | 38.6889 | 0.5602 | 38.3744 | 0.2457 | 56.1 | |
| Commercial Nitric | 15 | 38.0742 | 38.6334 | 0.5592 | 38.2378 | 0.1636 | 70.7 | 69% |
| acid, 53% active | 16 | 38.0401 | 38.6023 | 0.5622 | 38.2218 | 0.1817 | 67.7 | |
| Commercial acidic | 17 | 38.1441 | 38.7022 | 0.5581 | 38.2943 | 0.1502 | 73.1 | 69% |
| cleaner | 18 | 38.0845 | 38.6448 | 0.5603 | 38.2782 | 0.1937 | 65.4 | |
| Commercial alkaline | 19 | 38.2520 | 38.8116 | 0.5596 | 38.2545 | 0.0025 | 99.6 | 100% |
| cleaner | 20 | 38.1296 | 38.6848 | 0.5552 | 38.1315 | 0.0019 | 99.7 | |

Table 3 shows the conductivities and % average cleaning performances of the cleaning solutions containing 1 wt % of the disclosed acid cleaner composition (AC-1 or AC-2) or the disclosed alkaline cleaner composition (AL-1 or AL-2), in comparison to those of the control tap water, the commercial acidic cleaning solution, the commercial basic cleaning solution, the commercial nitric acid, and the commercial caustic soda.

TABLE 3

| Cleaning Solution containing | Conductivity of the | Cleaning |
|---|---|---|
| 1% wt of the following | Cleaning Solution | Performance |
| Cleaner Composition | (mS/cm at 25° C.) | (% averaged) |
| Tap Water | 0.8 | 49 |
| Acid Cleaner Composition | | |
| AC-1 | 2.8 | 98 |
| AC-2 | 1.9 | 96 |
| Commercial Acid Cleaner | 12.3 | 69 |
| Commercial Nitric Acid, 53% active | 33.5 | 69 |
| Alkaline Cleaner Composition | | |
| AL-1 | 1.0 | 78 |
| AL-2 | 0.8 | 87 |
| Commercial Alkaline Cleaner | 13.2 | 100 |
| Commercial Caustic Soda, 50% | 27.8 | 60 |
| active | | |

As shown in Table 3, the disclosed cleaning solution (containing 1% by weight of the cleaner composition AC-1, AC-2, AL-1, or AL-2) provided at least about the same cleaning performance as the cleaning solutions obtained from the commercial cleaners. The disclosed cleaning solution had the conductivity of up to 8 mS/cm, which was substantially lower than the cleaning solutions obtained from the commercial cleaners. Thus, upon using the disclosed cleaning solution, the generated waste effluent had a sufficiently low conductivity level that allowed its use as irrigation water without the need for reducing the conductivity prior to the irrigation use.

Therefore, the method of cleaning the soiled plate using the disclosed cleaning solution not only provided the waste effluent suitable for irrigation use, but also maintained the cleaning performance of the commercial cleaners.

1. A method of cleaning an automated recirculation system and using waste effluent produced therefrom, the method comprising:
cleaning the automated recirculation system having its surface substantially free of burnt-in soil, with a cleaning solution that has a conductivity of up to 8 mS/cm at 25° C. and comprises an acidic agent or an alkaline agent;
generating a waste effluent; and
using the waste effluent as irrigation water without reducing conductivity of the waste effluent prior to irrigation use,
wherein the method provides at least the same cleaning performance as a method that uses a cleaning solution comprising 1% by weight of caustic soda at 50% active or a cleaning solution comprising 1% by weight of nitric acid at 53% active.

2. The method of claim 1, wherein the automated recirculation system comprises a clean-in-place (CIP) process.

3. The method of claim 1, wherein the automated recirculation system is in a processing plant for processed food, dairy, brewing, or beverage.

4. The method of claim 1, further comprising preparing the cleaning solution from a cleaner composition by diluting the cleaner composition with a diluent.

5. A method of cleaning an equipment and using waste effluent produced therefrom, the method comprising:
preparing a cleaning solution having a conductivity of up to 8 mS/cm at 25° C. that comprises an acidic agent or alkaline agent;
contacting the equipment to be cleaned with the cleaning solution for a time needed to achieve a desired extent of soil removal and generating a waste effluent, wherein the surface of the equipment to be cleaned is substantially free of burnt-in soil;
discharging the generated waste effluent from the equipment; and
using the waste effluent without reducing conductivity of the waste effluent prior to use, wherein the waste effluent has a conductivity of no more than 8 mS/cm at 25° C., and
wherein the method provides at least the same cleaning performance as a method that uses a cleaning solution comprising 1% by weight of caustic soda at 50% active or a cleaning solution comprising 1% by weight of nitric acid at 53% active.

6. The method of claim 5, wherein using the waste effluent comprises using the waste effluent as irrigation water without reducing conductivity of the waste effluent prior to irrigation use.

7. The method of claim 5, wherein the equipment includes a processing equipment in a processed food, dairy, brewing, or beverage processing operation.

8. The method of claim 5, wherein the cleaning solution has a conductivity up to 5 mS/cm at 25° C.

9. The method of claim 5, wherein the cleaning solution comprises the acidic agent, and wherein the acidic agent fulfills at least one of the following:
(A) the acidic agent comprises methane sulfonic acid, methane sulfonic acid derivative, sulfamic acid, sulfamic acid derivative, alpha-hydroxy acid, alpha-hydroxy acid derivative, formic acid, formic acid derivative, acetic acid, acetic acid derivative citric acid, citric acid derivative, propionic acid, propionic acid derivative, glutamic acid, glutamic acid derivative, gluconate, gluconate derivative, glycolic acid, glycolic acid derivative, or any combination thereof;
(B) the acidic agent is present in an amount from about 0.01 wt % to about 5 wt % based on total weight of the cleaning solution.

10. The method of claim 5, wherein the cleaning solution comprises the alkaline agent, and wherein the alkaline agent fulfills at least one of the following:
(a) the alkaline agent comprises ammonia, monoethanolamine, triethanolamine, diglycolamine, or any combination thereof;
(b) the alkaline agent is present in an amount from about 0.01 wt % to about 5 wt % based on total weight of the cleaning solution;
(c) the alkaline agent comprises monoethanolamine in an amount from about 0.01 wt % to about 5 wt % based on total weight of the cleaning solution; or
(d) the alkaline agent comprises triethanolamine in an amount from about 0.01 wt % to about 5 wt % based on total weight of the cleaning solution.

11. The method of claim 1, wherein the cleaning solution further comprises a buffer, a hydrotrope, a sequestrant, a solvent, a stabilizer, a biocide, a surfactant, a degreaser, an optically active dye, or any mixture thereof.

12. The method of claim 1, wherein the method further comprises collecting the waste effluent, or diluting the waste effluent solution with a diluent, or both, before using the waste effluent solution as irrigation water.

13. The method of claim 1, wherein the method further comprises:
analyzing fluid stream of the automated recirculation system or equipment to determine a concentration of the cleaning solution, preferably the analyzing is performed by an in-line measurement; and
implementing at least one process change required to achieve a desired concentration of the cleaning solution in the fluid stream.

14. The method of claim 13, wherein implementing at least one process change comprises: adjusting a concentration of the cleaner composition used for preparing the cleaning solution, adjusting a dosage volume of the cleaner composition used for preparing the cleaning solution, changing flow rate of the fluid stream in the automated recirculation system or processing equipment, adjusting a cleaning temperature, or any combination thereof.

15. The method of claim 1, wherein the method further comprises
cleaning the automated recirculation system or equipment with a second cleaning solution before using the waste effluent for the irrigation use, and
wherein the second cleaning solution has a lower conductivity than the cleaning solution having a conductivity of up to 8 mS/cm at 25° C.

16. The method of claim 1, wherein the cleaning solution has a conductivity up to 5 mS/cm at 25° C.

17. The method of claim 1, wherein the cleaning solution comprises the acidic agent, and wherein the acidic agent comprises methane sulfonic acid, methane sulfonic acid derivative, sulfamic acid, sulfamic acid derivative, alpha-hydroxy acid, alpha-hydroxy acid derivative, formic acid, formic acid derivative, acetic acid, acetic acid derivative citric acid, citric acid derivative, propionic acid, propionic acid derivative, glutamic acid, glutamic acid derivative, gluconate, gluconate derivative, glycolic acid, glycolic acid derivative, or any combination thereof.

18. The method of claim 1, wherein the cleaning solution comprises the acidic agent in an amount from about 0.01 wt % to about 5 wt % based on total weight of the cleaning solution.

19. The method of claim 1, wherein the cleaning solution comprises the alkaline agent, and wherein the alkaline agent comprises ammonia, monoethanolamine, triethanolamine, diglycolamine, or any combination thereof.

20. The method of claim 1, wherein the cleaning solution comprises the alkaline agent in an amount from about 0.01 wt % to about 5 wt % based on total weight of the cleaning solution.
